(19) United States
(12) Patent Application Publication
(10) Pub. No.: US 2025/0390698 A1
(43) Pub. Date: Dec. 25, 2025

(54) CARD CONNECTOR

(71) Applicant: Chiun Hui Technology Co.,Ltd., New Taipei (TW)

(72) Inventor: Shu-Chu KUNG, New Taipei (TW)

(21) Appl. No.: 18/753,496

(22) Filed: Jun. 25, 2024

(51) Int. Cl. G06K 19/077; H01R 13/629

(52) U.S. Cl. CPC G06K 19/07745; H01R 13/629

(57) ABSTRACT

A card connector includes an insulating base having an accommodating space inside and two side arms located on both sides and respectively provided with a storage slot, a shell covering the insulating base and having two locking devices respectively provided with an elastic arm extended downwardly from said shell in a curved manner and buckled into one respective storage slot, and a sliding seat having a seat body with a receiving slot for accommodating a preset electronic card and two first recesses provided on two opposite side edges for the positioning of the elastic arms respectively. After the sliding seat is pushed in, the elastic arms of the shell are positioned at the first recesses at the same time to achieve the effect of correcting the position of both sides of the sliding seat without deviation to the left or right.

### BACKGROUND OF THE INVENTION

### 1. Field of the Invention

The invention relates to a card connector, in particular to a shell covering an insulating base with locking devices on both sides thereof, so that the sliding seat cooperates with the locking devices on both sides of the shell to form a position while maintaining the balance on both sides, thereby achieving the effect of correcting the position of the sliding seat from being deviated to the left or right.

### 2. Description of the Related Art

With the advancement of technology today, electronic products, especially mobile devices such as smartphones, tablets, laptops, and digital cameras have been widely integrated into people's lives. Moreover, these products produced by different manufacturers and brands also have different transmission and storage devices, and thus require various connectors to connect the devices.

Today's various mobile devices also use external electronic cards to expand memory capacity and store more data, files or applications such as multimedia memory cards (MMC), secure digital cards (SD), smart media cards (SM), compressed flash cards (CE), memory cards (MS), electronic chip cards or subscriber function identification cards (SIM), etc. The connectors used in various mobile devices and electronic devices provide a relatively stable plug-in environment to avoid the deviation of the electronic cards during contact, thereby causing unstable connections. This is the key point that those engaged in this industry urgently want to study and improve.

### SUMMARY OF THE INVENTION

Therefore, in view of the above problems and deficiencies, the inventor collected relevant information, evaluated and considered from various parties, and based on years of experience accumulated in this industry, through continuous trials and revisions, to design this card connector.

It is therefore the main object of the present invention to provide a card connector, which comprises an insulating base, a shell and a sliding seat. The insulating base comprises an accommodating space inside, a terminal set set therein, a pushing device assembled on at least one side thereof, and two side arms respectively extended from two sides thereof. Each said side arm is provided with a storage slot. The shell covers the insulating base. The shell comprises two locking devices respectively on two sides thereof corresponding to the storage slots of the two side arms. Each locking device comprises an elastic arm extended downwardly from said shell in a curved manner and buckled into one respective storage slot. The elastic arm is provided with a protruding portion protruding inward. The sliding seat comprises a seat body, a receiving slot located on the seat body for accommodating a preset electronic card, a resisting wall provided on one side of the seat body to face the insulating base, two opposite side edges respectively extended from two sides of the resisting wall, a first recess provided on each of the two opposite side edges for positioning of the protruding portion of each elastic arm, a second recess provided on each of the two opposite side edges between the first recess and the resisting wall, and a force applying portion provided on an opposite side of the resisting wall of the seat body. After the sliding seat is pushed into the accommodating space of the insulating base, the protruding portions of the elastic arms on both sides of the shell are positioned at the first recesses at the same time, and the positions of two sides of the sliding seat are corrected to avoid deviation to the left or right.

Another object of the present invention is that each elastic arm of the insulating base comprises two folded end portions respectively extended from two sides thereof and connected to the shell. This reduces the outward movement of the elastic arms, thereby reducing the left and right movement of the sliding seat when it is pushed into the accommodating space, so that achieving the purpose of reducing the elastic fatigue of the elastic arms due to frequent movements.

Still another object of the present invention is that the pushing device comprises a connecting rod and a push rod. The connecting rod comprises a fixing hole fastened to at least one fixed column provided in the insulating base to form a positioning, a resisting portion extended from one side of the connecting rod, a resisting surface formed on one side of the resisting portion to face the accommodating space, a push surface extending obliquely at a end of the resisting portion adjacent to the resisting surface, a positioning portion extended from an opposite side of the connecting rod in a curved manner, and an inwardly curved abutment surface formed on one side of the positioning portion to face the accommodating space. The push rod comprises a positioning groove on one side thereof for assembly of the positioning portion, a J-shaped pushing portion extended from an opposite side of the positioning groove, a pushing surface formed on the J-shaped pushing portion, and a pushing groove located on the pushing surface.

Still another object of the present invention is that the push rod of the pushing device further comprises a limiting block located between the positioning groove and the J-shaped pushing portion; the shell further comprises a limiting groove on the surface thereof corresponding to the position of the limiting block of the push rod and larger than the limiting block.

Still another object of the present invention is that each side arm of the insulating base is provided with a plurality of first positioning protrusions on an outer wall thereof; the shell further comprises two first peripheral walls respectively bent and extended on two sides thereof, and a plurality of first positioning holes respectively located on the two first peripheral walls corresponding to the first positioning protrusions.

Still another object of the present invention is that the insulating base further comprises a plurality of second positioning protrusions on an outer lateral wall thereof; the shell further comprises a second peripheral wall between the two first peripheral walls, and a plurality of second positioning holes respectively located on the second peripheral wall corresponding to the second positioning protrusions.

Still another object of the present invention is that each first recess has two vertical walls at right angles on both sides; each second recess has two inclined beveled walls on both sides.

### BRIEF DESCRIPTION OF THE DRAWINGS

FIG. 1 is a three-dimensional appearance view of the card connector of the present invention.

FIG. 2 is a three-dimensional exploded view of the card connector of the present invention.

FIG. 3 is a three-dimensional exploded view of the card connector of the present invention from another perspective.

FIG. 4 is a schematic assembly diagram of the insulating base of the card connector of the present invention.

FIG. 5 is a schematic assembly diagram of the insulating base of the card connector of the present invention from another perspective.

FIG. 6 is a top cross-sectional view of the card entry of the card connector of the present invention.

FIG. 7 is a top cross-sectional view of the card connector of the present invention when the card is withdrawn.

### DETAILED DESCRIPTION OF THE PREFERRED EMBODIMENT

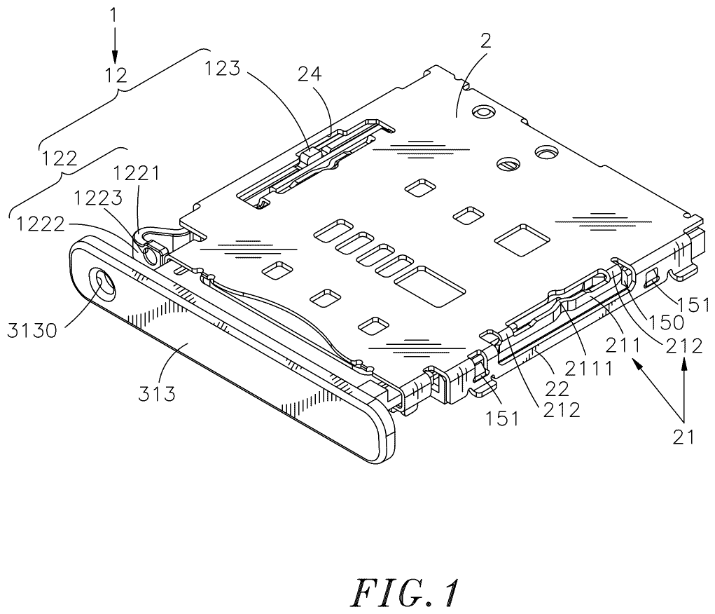

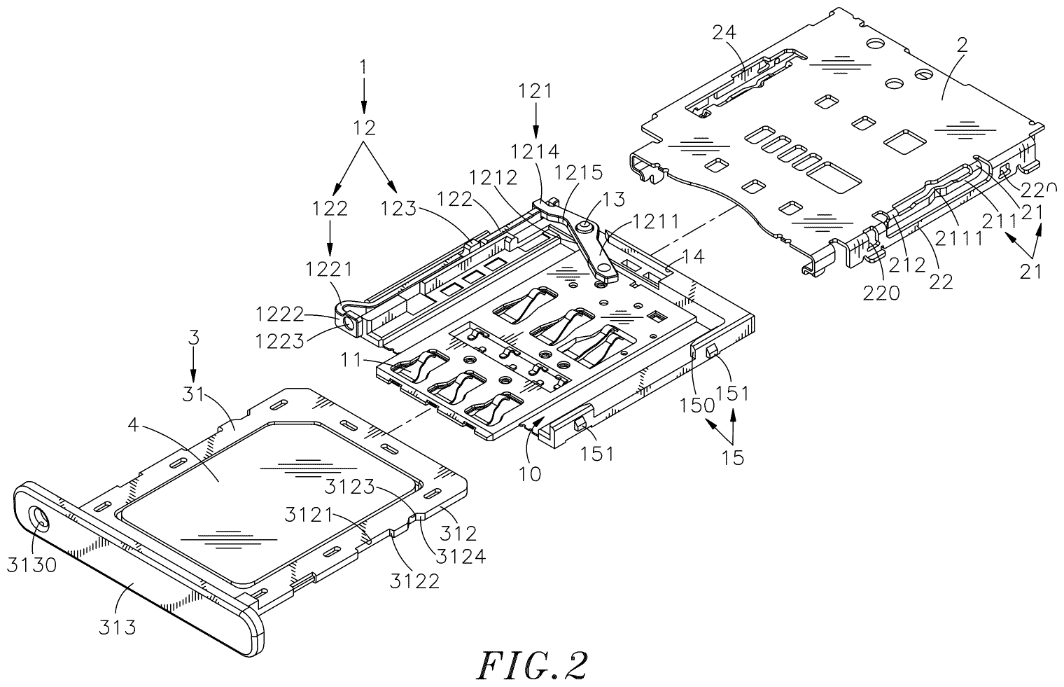

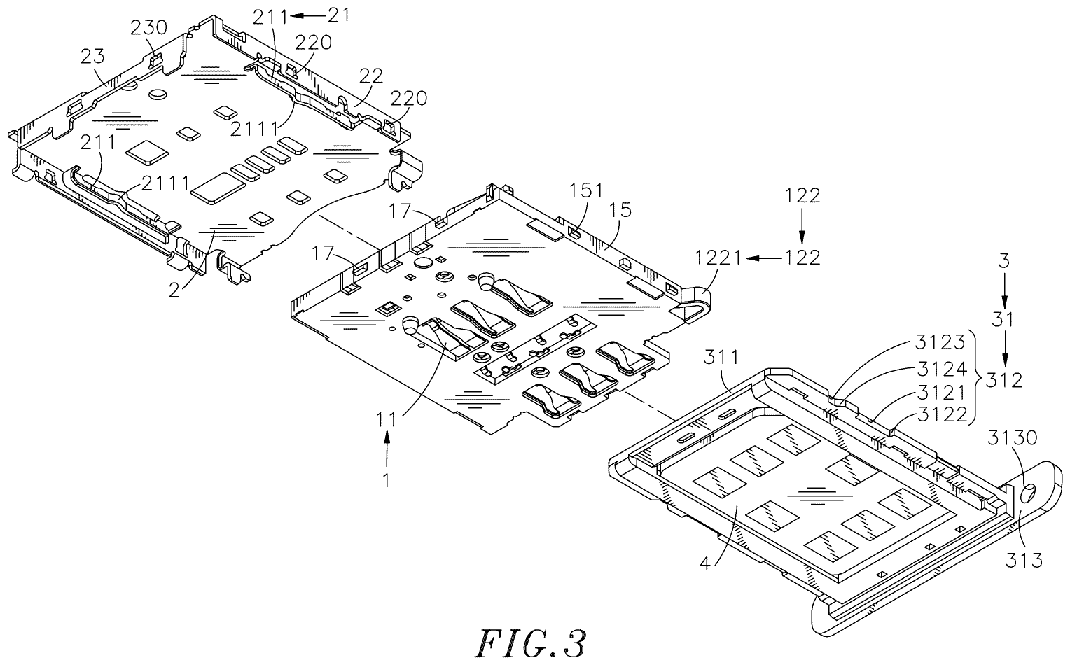

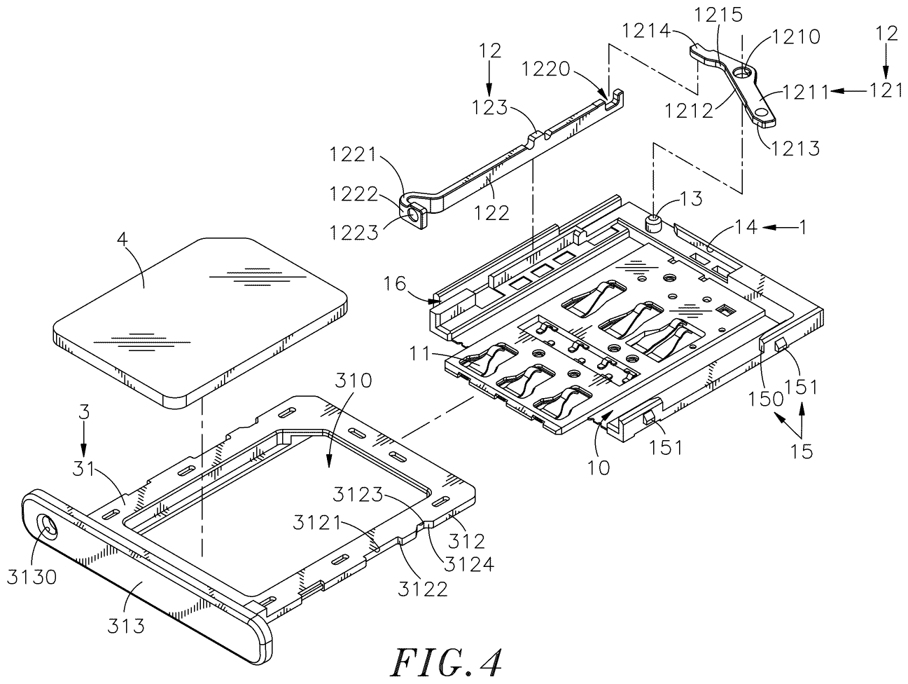

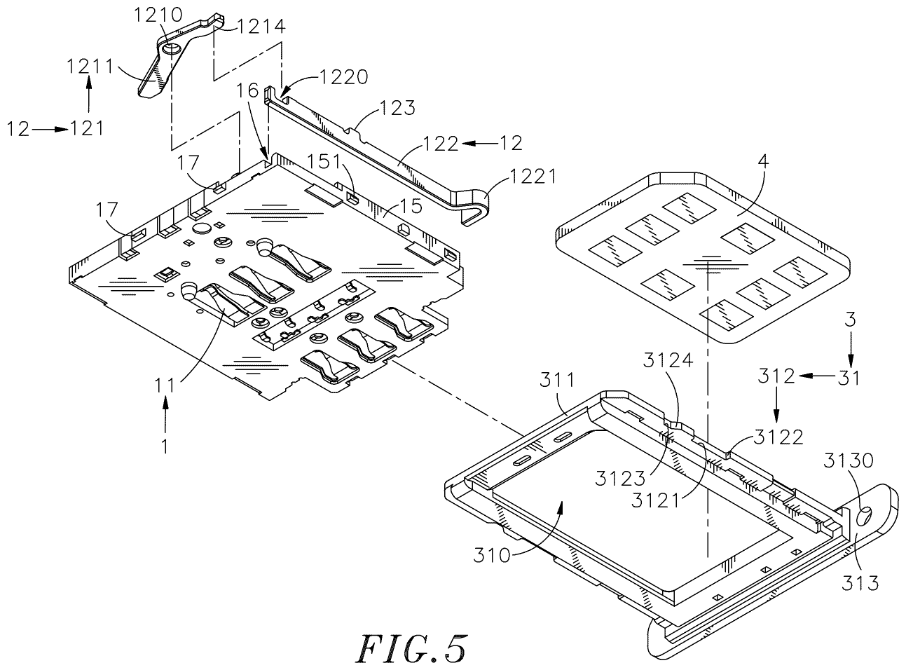

Please refer to FIGS. 1-5, which are three-dimensional appearance view of the card connector of the present invention, three-dimensional exploded view of the card connector of the present invention, three-dimensional exploded view of the card connector of the present invention from another perspective, schematic assembly diagram of the insulating base of the card connector of the present invention and schematic assembly diagram of the insulating base of the card connector of the present invention from another perspective. The card connector of the present invention mainly comprises an insulating base 1, a shell 2 and a sliding seat 3, and the connection relationship between the aforementioned components is as follows:

The insulating base 1 comprises an accommodating space 10 inside, a terminal set 11 set therein, a fixed column 13 provided on at least one side thereof, a pushing device 12 mounted on the fixed column 13, a storage space 14 recessed adjacent to one side of the fixed column 13, two side arms 15 extended from two opposite lateral sides of the insulating base 1, each side arm 15 being provided with a storage slot 150 in the middle and a plurality of first positioning protrusions 151 on the outer wall at two opposite lateral sides of the storage slot 150, a sliding channel 16 provided on one lateral side of the insulating base 1 for a push rod 122 to slide, and a plurality of second positioning protrusions 17 provided on the outer lateral wall of the insulating base 1. The pushing device 12 comprises a connecting rod 121 and the push rod 122. The connecting rod 121 comprises a fixing hole 1210 that is sleeved on the fixed column 13 to form a positioning, a resisting portion 1211 extended from one side of the pushing device 12 and located in the storage space 14, a resisting surface 1212 formed on one side of the resisting portion 1211 to face the accommodating space 10, a push surface 1213 extending obliquely at the end of the resisting portion 1211 adjacent to the resisting surface 1212, a positioning portion 1214 extended from an opposite side of the resisting portion 1211 in a curved manner, and an inwardly curved abutment surface 1215 formed on one side of the positioning portion 1214 to face the accommodating space 10. The push rod 122 comprises a positioning groove 1220 on one side thereof for assembly of the positioning portion 1214, a J-shaped pushing portion 1221 extended from an opposite side of the positioning groove 1220, a pushing surface 1222 formed on the J-shaped pushing portion 1221, a pushing groove 1223 located on the pushing surface 1222, and a limiting block 123 protrude from the push rod 122.

The shell 2 covers the insulating base 1. The shell 2 comprises two locking devices 21 respectively provided on two opposite lateral sides thereof corresponding to the storage slots 150, each locking device 21 comprises an elastic arm 211 that has two folded end portions 212 connected to the shell 2 so that the elastic arm 211 is extended downwardly from the shell 2 in a curved manner and buckled into each storage slot 150, each elastic arm 211 is further provided with a protruding portion 2111 protruding inwardly, and two first peripheral walls 22 respectively bent and extended on two opposite lateral sides of the shell 2, a plurality of first positioning holes 220 respectively located on the two first peripheral walls 22 corresponding to the first positioning protrusions 151, a second peripheral wall 23 provided between the two first peripheral walls 22, a plurality of second positioning holes 230 respectively located on the second peripheral wall 23 corresponding to each second positioning protrusion 17 of the insulating base 1, and a limiting groove 24 provided on the surface of the shell 2 corresponding to the position of the limiting block 123 of the push rod 122 and larger than the limiting block 123.

The sliding seat 3 comprises a seat body 31, a receiving slot 310 located on the seat body 31 for accommodating a preset electronic card 4 (such as a secure digital card, a memory card or an identification card, etc.), a resisting wall 311 provided on one side of the seat body 31 to face the insulating base 1, two opposite side edges 312 respectively extended from two sides of the resisting wall 311, a first recess 3121 provided on each of the two opposite side edges 312, each first recess 3121 having two vertical walls 3122 at right angles on both sides thereof, a second recess 3123 provided between the first recess 3121 and the resisting wall 311, each second recess 3123 having two beveled walls 3124 in a inclined manner on both sides thereof, a force applying portion 313 provided on an opposite side of the resisting wall 311 of the seat body 31, and a through hole 3130 located on the force applying portion 313 and aligned with the pushing groove 1223.

Furthermore, when the present invention is to be made into a structure, the terminal set 11 is first injection molding into the insulating base 1, and then the fixing hole 1210 of the connecting rod 121 of the pushing device 12 is set onto the fixed column 13 provided on the insulating base 1 for fixation, so that the resisting portion 1211 provided on one side of the connecting rod 121 will be located in the storage space 14 of the insulating base 1, and the push rod 122 of the pushing device 12 will be located in the sliding channel 16 of the insulating base 1, and the positioning groove 1220 on one side of the push rod 122 adjacent to the connecting rod 121 is for the positioning portion 1214 of the connecting rod 121 to be stored and positioned. The shell 2 is then covered outside the insulating base 1, so that the first positioning holes 220 of the first peripheral walls 22 on both sides of the shell 2 are respectively attached onto the first positioning protrusions 151 outside the insulating base 1, and the second positioning holes 230 on the second peripheral wall 23 of the shell 2 are respectively attached onto the second positioning protrusions 17 outside the insulating base 1, and the locking devices 21 located on both sides of the shell 2 are buckled into the storage slots 150 of the side arms 15 corresponding to both sides of the insulating base 1. Then the preset electronic card 4 is assembled in the receiving slot 310 of the seat body 31 of the sliding seat 3. By applying force to the force applying portion 313 of the sliding seat 3 and pushing it inward, so that the seat body 31 of the sliding seat 3 is pushed into the accommodating space 10 of the insulating base 1. This completes the overall structure of the card connector of the present invention.

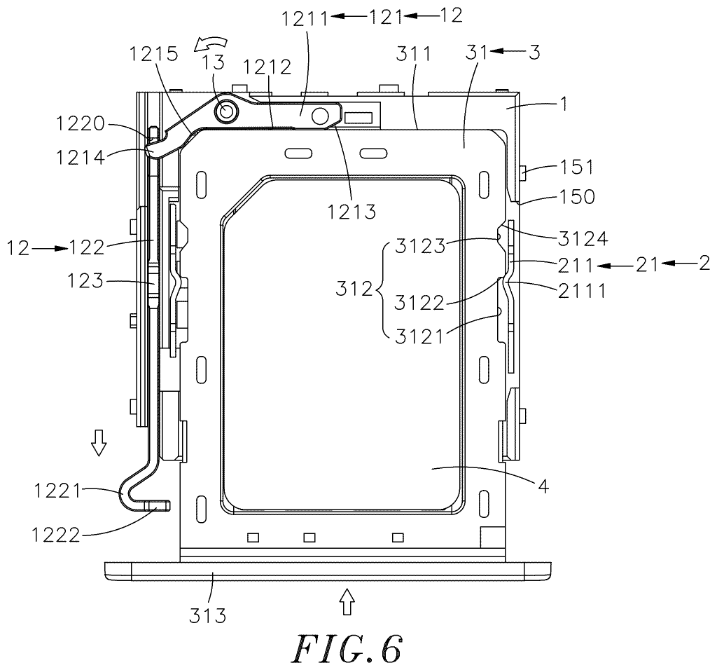

Please refer to FIGS. 1, 6 and 7, which are three-dimensional appearance view of the card connector of the present invention, top cross-sectional view of the card entry of the card connector of the present invention and top cross-sectional view of the card connector of the present invention when the card is withdrawn. It can be clearly seen from the figures that in order to push the sliding seat 3 in for fixation, the resisting wall 311 of the seat body 31 of the sliding seat 3 can be pushed in and resisted against the resisting surface 1212 of the resisting portion 1211 of the connecting rod 121, so that the connecting rod 121 can be pushed into the storage space 14, and the positioning portion 1214 extended from one side of the connecting rod 121 in a curved manner can push the inner wall surface of the positioning groove 1220 of the push rod 122 outward through the thrust, so as to push the push rod 122 to move outward a distance by the thrust of the positioning portion 1214, and the limiting block 123 provided on the push rod 122 is limited to the limiting groove 24 of the shell 2 and will not move outward excessively. At the same time, as the sliding seat 3 is pushed in, the protruding portions 2111 protruding from the elastic arms 211 on both sides of the shell 2 will pass through the second recess 3123 and extend into the first recess 3121. The beveled walls 3124 on both sides of the second recess 3123 are inclined, which allows the protruding portions 2111 to move more easily without being positioned. The vertical walls 3122 of the first recess 3121 are respectively held by the protruding portions 2111 on both sides of the shell 2 and will not exit, so that the sliding seat 3 cooperates with the locking devices 21 on both sides to form a positioning and maintain the balance of both sides at the same time to achieve the effect of correcting the position of the sliding seat 3 without deviation.

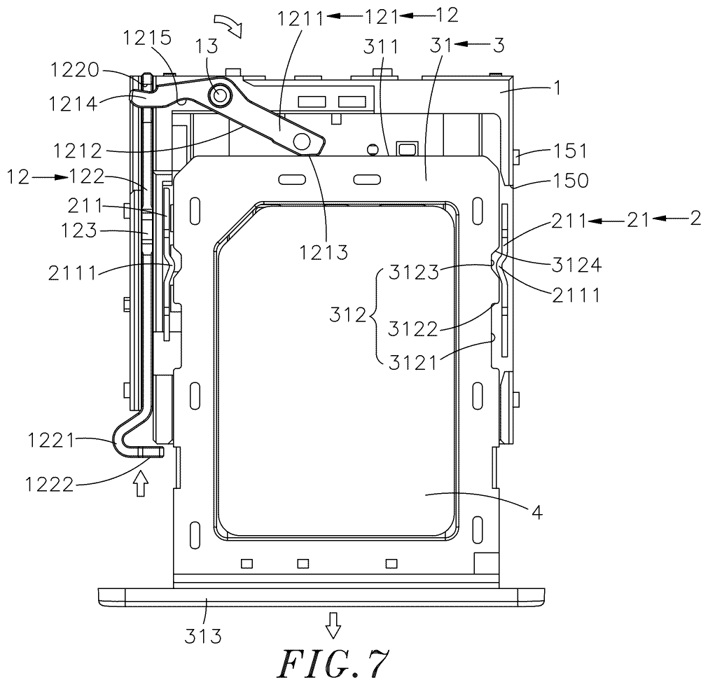

If you want to exit the sliding seat 3, you can push the pushing surface 1222 of the J-shaped pushing portion 1221 of the push rod 122, so that the push rod 122 slides inward along the sliding channel 16 to cause the positioning portion 1214 of the connecting rod 121 in the positioning groove 1220 of the push rod 122 to be tilted outward by the thrust of the push rod 122. And the push surface 1213 of the push rod 122 will tilt outward at an angle and then push against the surface of the resisting wall 311 of the sliding seat 3, and push the sliding seat 3 outward a distance. Then, each protruding portion 2111 originally located in each first recess 3121 is displaced into the second recess 3123 as the sliding seat 3 is pushed outward (as shown in FIG. 7), thereby completing the card entry and exit of the card connector of the present invention.

In addition, the above-mentioned sliding seat 3 can further push the pushing groove 1223 on the pushing surface 1222 of the push rod 122 by using the shank of a screwdriver to pass through the through hole 3130 on the surface of the force applying portion 313. This will achieve the effect of card exit.

Furthermore, each above-mentioned elastic arm 211 is connected to the shell 2 through the folded end portions 212 at both sides thereof, thereby reducing the outward movement of the elastic arm 211. This reduces the left and right movement of the sliding seat 3 when it is pushed into the accommodating space 10, thereby achieving the purpose of reducing the elastic fatigue of the elastic arms 211 due to frequent movements.

In addition, the present invention is mainly directed to the insulating base 1 having at least one pushing device 12 inside, and the insulating base 1 being covered with the shell 2 having the locking devices 21 on both sides thereof. The main feature is that when the sliding seat 3 is pushed in, it can cooperate with the locking devices 21 on both sides of the shell 2 for a positioning and correct the left and right positions of the sliding seat 3 without causing deviation at the same time. Another feature is that each elastic arm 211 is connected to the shell 2 through the folded end portions 212 at both sides thereof to reduce the left and right movement of the sliding seat 3 when it is pushed into the accommodating space 10, thereby reducing the elastic fatigue of the elastic arms 211 due to frequent movements.

The above description is only a preferred embodiment of the present invention, and does not limit the patent scope of the present invention. Therefore, all simple modifications and equivalent structural changes made by using the contents of the description and drawings of the present invention shall be included in the patent scope of the present invention and shall be clearly stated.

To sum up, the card connector of the present invention can indeed achieve its efficacy and purpose when it is used. Therefore, the present invention is an invention with excellent practicability and meets the application requirements for an invention patent. I would like to file an application in accordance with the law, and hope that the review committee will approve the application as soon as possible to protect the inventor's hard work. If there is any doubt from the review committee of the Bureau, please do not hesitate to send a letter to instruct, and the inventor will do his best to cooperate.

What the invention claimed is:

1. A card connector, comprising:
an insulating base comprising an accommodating space inside, a terminal set set therein, a pushing device assembled on at least one side thereof and two side arms respectively extended from two opposite lateral sides thereof, each said side arm being provided with a storage slot;
a shell covering said insulating base, said shell comprising two locking devices respectively provided at two opposite lateral sides thereof corresponding to said storage slots of two said side arms, each said locking device comprising an elastic arm extended downwardly from said shell in a curved manner and buckled into each said storage slot, said elastic arm being provided with a protruding portion protruding inward; and
a sliding seat comprising a seat body, a receiving slot located on said seat body for accommodating a preset electronic card, a resisting wall provided on one side of said seat body to face said insulating base, two opposite side edges respectively extended from two opposite sides of said resisting wall, a first recess provided on each of said two opposite side edges for positioning of said protruding portion of each said elastic arm, a second recess provided on each of said two opposite side edges between said first recess and said resisting wall, and a force applying portion provided on an opposite side of said resisting wall of said seat body;
wherein after said sliding seat is pushed into said accommodating space of said insulating base, said protruding portions of said elastic arms on both sides of said shell are positioned at said first recesses at the same time, and the positions of two sides of said sliding seat are corrected to avoid deviation.

2. The card connector as claimed in claim 1, said pushing device comprises a connecting rod and a push rod, said connecting rod comprising a fixing hole fastened to at least a fixed column provided in said insulating base to form a positioning, a resisting portion extended from one side of said connecting rod, a resisting surface formed on one side of said resisting portion to face said accommodating space, a push surface extending obliquely at a end of said resisting portion adjacent to said resisting surface, a positioning portion extended from an opposite side of said connecting rod in a curved manner and an inwardly curved abutment surface formed on one side of said positioning portion to face said accommodating space, a positioning groove provided on one side of said connecting rod for assembly of said positioning portion, a J-shaped pushing portion extended from an opposite side of said positioning groove, a pushing surface formed on said J-shaped pushing portion and a pushing groove located on said pushing surface.

3. The card connector as claimed in claim 2, wherein said push rod of said pushing device further comprises a limiting block located between said positioning groove and said J-shaped pushing portion; said shell further comprises a limiting groove on the surface thereof corresponding to the position of said limiting block and larger than said limiting block.

4. The card connector as claimed in claim 2, wherein said insulating base further comprises a storage space recessed adjacent to one side of said fixed column for receiving said resisting portion.

5. The card connector as claimed in claim 2, wherein said insulating base further comprises a sliding channel on at least one side thereof for said push rod to slide.

6. The card connector as claimed in claim 2, wherein said force applying portion is provided with a through hole aligned with said pushing groove.

7. The card connector as claimed in claim 1, wherein each said side arm of said insulating base is provided with a plurality of first positioning protrusions on an outer wall thereof; said shell further comprises two first peripheral walls respectively bent and extended on two opposite lateral sides thereof, and a plurality of first positioning holes respectively located on said two first peripheral walls corresponding to said first positioning protrusions.

8. The card connector as claimed in claim 7, wherein said insulating base further comprises a plurality of second positioning protrusions provided on an outer lateral wall thereof; said shell further comprises a second peripheral wall between said two first peripheral walls, and a plurality of second positioning holes respectively located on said second peripheral wall corresponding to said second positioning protrusions.

9. The card connector as claimed in claim 1, wherein each said elastic arm of said insulating base comprises two folded end portions respectively extended from two opposite ends thereof and connected to said shell.

10. The card connector as claimed in claim 1, wherein each said first recess has two vertical walls at right angles on both sides; each said second recess has two inclined beveled walls on both sides.
